(19) United States
(12) Patent Application Publication
(10) Pub. No.: US 2025/0092243 A1
(43) Pub. Date: Mar. 20, 2025

(54) PVA COMPOSITE WITH IMPROVED HYDROPHOBICITY AND MANUFACTURING METHOD THEREOF

(71) Applicant: Green Package Solution Co., Ltd, Gumi-si, Gyeongsangbuk-do (KR)

(72) Inventor: Sung Hun AHN, Yongin-si, Gyeonggi-do (KR)

(73) Assignee: Green Package Solution Co., Ltd, Gumi-si, Gyeongsangbuk-do (KR)

(21) Appl. No.: 18/528,805

(22) Filed: Dec. 5, 2023

(30) Foreign Application Priority Data
Sep. 20, 2023 (KR) 10-2023-0125226
Nov. 21, 2023 (KR) 10-2023-0162132

(51) Int. Cl. C08L 29/04

(52) U.S. Cl. CPC C08L 29/04

(57) ABSTRACT

The present disclosure relates to a PVA composite with improved hydrophobicity and a manufacturing method thereof, wherein a biodegradable PVA composite has excellent oxygen barrier properties and moisture barrier properties, and thus, may be used as a food plastic and the PVA composite includes polyvinyl alcohol (PVA) and poly acrylic acid (PAA).

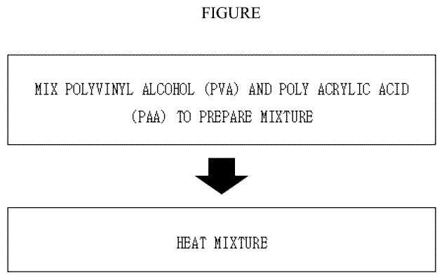

### CROSS-REFERENCE TO RELATED APPLICATION

This application claims priority to Korean Patent Application No. 10-2023-0125226 filed on Sep. 20, 2023 and Korean Patent Application No. 10-2023-0162132 filed on Nov. 21, 2023 and all the benefits accruing therefrom under 35 U.S.C. § 119, the contents of which are incorporated by reference in their entirety.

### BACKGROUND

The present disclosure relates to a PVA composite with improved hydrophobicity and a manufacturing method thereof. An embodiment of the present disclosure is a biodegradable PVA composite, which has excellent oxygen barrier properties and moisture barrier properties, and thus, may be used as a food plastic.

Polyvinyl alcohol (PVA) is a water-soluble polymer and is known as a biodegradable polymer. Due to these properties, PVA is used not only for vascular stents and contact lenses, but also for straws, food containers, packaging films, and the like that require biodegradability.

However, PVA has a degree of swelling of 104.8% and a contact angle of 22.52° with water, and thus, is vulnerable to water, so that there is a problem in using PVA for straws or food containers.

The prior art document discloses a biodegradable resin composition with improved biodegradability by mixing PVA, PE, and the like.

### PRIOR ART DOCUMENT

### Patent Document

(Patent Document 0001) Korean Patent Laid-Open Publication No. 10-2022-0059099

### SUMMARY

The present disclosure provides a PVA composite with excellent hydrophobicity and a manufacturing method thereof.

In addition, the PVA composite manufactured by the present disclosure has excellent biodegradability.

In addition, the PVA compound manufactured by the present disclosure has excellent oxygen barrier properties.

In accordance with an exemplary embodiment of the present disclosure, a PVA composite includes polyvinyl alcohol and poly acrylic acid (PAA).

The content of the poly acrylic acid is approximately 20 parts by weight to approximately 30 parts by weight with respect to 100 parts by weight of the polyvinyl alcohol.

The poly acrylic acid may have a molecular weight of approximately 100,000 to approximately 500,000.

In accordance with another exemplary embodiment of the present disclosure, a method for manufacturing a PVA composite includes mixing polyvinyl alcohol (PVA) and poly acrylic acid (PAA) to prepare a mixture, and heating the mixture.

The content of the poly acrylic acid is approximately 20 parts by weight to approximately 30 parts by weight with respect to 100 parts by weight of the polyvinyl alcohol.

The preparing of the mixture may include preparing a polyvinyl alcohol solution, preparing a poly acrylic acid solution, and mixing the polyvinyl alcohol solution and the poly acrylic acid solution.

The heating of the mixture may be heating the mixture to approximately 160° C. to approximately 180° C.

### BRIEF DESCRIPTION OF THE DRAWINGS

Exemplary embodiments can be understood in more detail from the following description taken in conjunction with the accompanying drawings, in which:

The FIGURE is a flow diagram showing a method for manufacturing a PVA composite in accordance with an exemplary embodiment of the present disclosure.

### DETAILED DESCRIPTION OF EMBODIMENTS

Hereinafter, preferred embodiments of the present disclosure will be described as follows with reference to the accompanying drawings. However, embodiments of the present disclosure may be modified into various other forms, and the scope of the present disclosure is not limited to the embodiments described below. In addition, the embodiments of the present disclosure are provided in order to more fully describe the present disclosure to those with average knowledge in the art.

A PVA composite according to an embodiment of the present disclosure includes polyvinyl alcohol (PVA) and poly acrylic acid (PAA). The PVA composite may have a bowl shape or a film shape, and may be manufactured by a manufacturing method to be described below. Therefore, the polyvinyl alcohol and the poly acrylic acid may be combined in various ways such as cross-linking and hydrogen bonding.

The polyvinyl alcohol (PVA) may provide flexibility and transparency to the PVA composite, impart high resistance to water thereto, and improve biodegradation properties thereof. The polyvinyl alcohol (PVA) may be represented by Structural Formula 1 below.

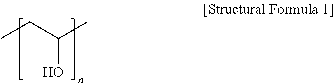

(where n is a natural number)

The poly acrylic acid (PAA) may be represented by Structural Formula 2 below.

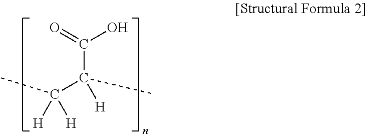

(where n is a natural number)

The present disclosure may increase a water contact angle and lower surface energy by mixing poly acrylic acid with polyvinyl alcohol. The molecular weight (Mw) of the poly acrylic acid may be from approximately 100,000 to approximately 500,000, and preferably approximately 250,000. The molecular weight (Mw) of poly acrylic acid that may be commonly obtained in the art is approximately 5,000, approximately 25,000, approximately 100,000, approximately 240,000, approximately 250,000, approximately 450,000, approximately 1,250,000, approximately 4,000,000, and the like. At this time, poly acrylic acid having a low molecular weight of approximately 5,000 or approximately 25,000 has increased moisture permeability, and thus, may have a problem of having reduced moisture barrier properties. In addition, poly acrylic acid having a high molecular weight of approximately 450,000, approximately 1,250,000, or approximately 4,000,000 has greatly reduced solubility with respect to a solvent, and thus, has a problem of not being sufficiently dissolved.

The content of the polyacrylic acid may be approximately 10 parts by weight to approximately 40 parts by weight, preferably approximately 20 parts by weight to approximately 30 parts by weight, and more preferably approximately 23 parts by weight to approximately 27 approximately with respect to 100 parts by weight of polyvinyl alcohol. If the content of the poly acrylic acid is too low, there is a problem in that the degree of cross-linking decreases, thereby increasing the degree of swelling, and if it is too high, there is a problem in that the rate of biodegradation decreases and the content of polyvinyl alcohol is lowered, thereby increasing oxygen permeability.

An embodiment may further include an additive such as a plasticizer such as glycerin, sorbitol, polyethylene glycol, etc., a cross-linking agent such as glutaraldehyde, cyclohexanone, etc., a stabilizer, or a pigment. In an embodiment, the additive may be added during a manufacturing process of a PVA composite and some or all of the additive may be changed to another material or removed from the resulting PVA composite.

A method for manufacturing a PVA composite according to an embodiment of the present disclosure includes mixing polyvinyl alcohol (PVA) and poly acrylic acid (PAA) to prepare a mixture, and heating the mixture.

In the step of preparing the mixture, the polyvinyl alcohol (PVA) and the poly acrylic acid (PAA) are the same as those described above. The polyvinyl alcohol and the poly acrylic acid may be used in a solid state, such as powder, or may be used in a state of being dissolved in a solvent.

In the step, the content of the poly acrylic acid may be approximately 20 parts by weight to approximately 30 parts by weight, more preferably approximately 23 parts by weight to approximately 27 approximately, with respect to 100 parts by weight of polyvinyl alcohol.

When polyvinyl alcohol and the poly acrylic acid are in a solid state, the step of preparing the mixture may include preparing a polyvinyl alcohol solution, preparing a poly acrylic acid solution, and mixing the polyvinyl alcohol solution and the poly acrylic acid solution.

In the step of preparing the polyvinyl alcohol solution, the polyvinyl alcohol may be used in the form of powder. The solvent used in the step is capable of dissolving the polyvinyl alcohol, and for example, may be deionized water. The step may include mixing the polyvinyl alcohol and the solvent to prepare a polyvinyl alcohol solution, heating the polyvinyl alcohol solution to approximately 70° C. to approximately 90° C., and cooling the polyvinyl alcohol solution to approximately 20° C. to approximately 30° C. (room temperature). The preparing of the polyvinyl alcohol solution may be performed by adding polyvinyl alcohol powder to a solvent. In the step, the weight ratio of the polyvinyl alcohol and the solvent, polyvinyl alcohol weight:solvent weight, may be approximately 1:5 to approximately 1:15, preferably approximately 1:8 to approximately 1:13, and most preferably approximately 1:8 to approximately 1:10. If there is too much of the solvent, a shape imparting process or a heating process is not smoothly performed, thereby increasing a defect rate, and if there is too little of the solvent, there is a problem in that the polyvinyl alcohol is not sufficiently dissolved. Next, the polyvinyl alcohol may be heated to be dissolved in the solvent. The step may be heating at a temperature below approximately 100° C., preferably approximately 70° C. to approximately 90° C., and may be performed for approximately 1 hour to approximately 2 hours. Next, the heated polyvinyl alcohol solution may be left to stand at room temperature or cooled to approximately 20° C. to approximately 30° C. using a chiller and the like. The step is to prevent a cross-linking reaction from occurring unevenly. If poly acrylic acid is added at high temperatures, the cross-linking reaction occurs locally, resulting in poor overall hydrophobicity.

The step of preparing the poly acrylic acid solution may be performed by adding polyacrylic acid powder to a solvent. The solvent is miscible with the polyacrylic acid (poly acrylic acid in a solution state), and for example, may be deionized water. In the step, the weight ratio of the poly acrylic acid and the solvent, poly acrylic acid weight:solvent weight, may be approximately 1:8 to approximately 1:12. If there is too much of the solvent, a shape imparting process or a heating process is not smoothly performed, thereby increasing a defect rate, and if there is too little of the solvent, the polyacrylic acid and the polyvinyl alcohol may not smoothly react with each other. The step may be performed at room temperature (approximately 20° C. to approximately 30° C.).

The mixing of the polyvinyl alcohol solution and the poly acrylic acid solution may be performed by mixing the polyvinyl alcohol solution and the polyacrylic acid solution which are previously prepared. The step may be stirring at room temperature for approximately 4 hours to approximately 10 hours such that the polyvinyl alcohol and the poly acrylic acid are sufficiently combined and evenly dispersed. In the step, the content of the poly acrylic acid may be approximately 20 parts by weight to approximately 30 parts by weight, more preferably approximately 23 parts by weight to approximately 27 approximately, with respect to 100 parts by weight of polyvinyl alcohol.

If both the polyvinyl alcohol and the poly acrylic acid are provided in a solution state dissolved in a solvent, the step may be performed by mixing the polyvinyl alcohol solution and the poly acrylic acid solution. In this case, the content of polyvinyl alcohol in the polyvinyl alcohol solution and the content of poly acrylic acid in the polyacrylic acid solution may be the same as those in the embodiment described above.

An embodiment may further include, before the heating of the mixture, imparting a shape to the mixture and drying the mixture.

The imparting of a shape to the mixture is imparting a desired shape to a PVA composite to be manufactured. If the PVA composite is a container, the imparting of a shape may be performed by pouring the mixture into a container-shaped mold, and if the PVA composite is a film, the imparting of a shape may be performed according to a casting method. The step may be performed by a common method of imparting a shape in the field of manufacturing products using resins, and is not specifically limited.

The drying step is removing the solvent from the mixture, and may include room-temperature drying and heating-drying. The step may be performed regardless of whether or not the imparting of a shape is performed, and may be performed before the imparting of a shape. Through the step, air bubbles contained in the mixture may be effectively removed, and a cross-linking reaction may occur evenly later, resulting in improving the quality of a PVA composite. The room-temperature drying may be performed at room temperature (approximately 20° C. to approximately 30° C.) for approximately 10 hours to approximately 30 hours, and the heating-drying may be performed at approximately 80° C. to approximately 90° C.) for approximately 1 hour to approximately 2 hours.

The heating of the mixture a step of causing a cross-linking reaction. The step may be heating the mixture to approximately 150° C. or higher, preferably approximately 160° C. to approximately 180° C., and more preferably approximately 165° C. to approximately 175° C., and may be performed for 1 hour to 2 hours.

### Examples Manufacturing of PVA Composite

For the manufacturing of a PVA composite, polyvinyl alcohol manufactured by Thermo Scientific Co. (saponification degree of 98% to 99%), poly acrylic acid manufactured by Waco Chemical Co. (Mw of 25,000) and manufactured by Sigma-Aldrich (Mw of 100,000, and 250,000) were used.

Example 1:20 g of polyvinyl alcohol was added to 250 g of deionized water and dissolved by stirring at 80° C. to prepare a polyvinyl alcohol solution. After all of the polyvinyl alcohol was dissolved, the mixture was slowly cooled to room temperature (25° C.). Next, 5 g of poly acrylic acid having a MW of 25,000 was added to 50 g of deionized water and dissolved by stirring at room temperature to prepare a poly acrylic acid solution. Next, the polyvinyl alcohol solution and the poly acrylic acid solution were mixed and then stirred at room temperature for 4 hours to prepare a mixture. Next, the mixture was poured into a Teflon mold having a thickness of 1 mm, dried at room temperature (25° C.) for one day, and then put into an oven and dried at 90° C. for 2 hours to prepare a transparent film. Next, the composite was put into an oven and heated at 170° C. for 1 hour to allow a cross-linking reaction to occur, thereby manufacturing a PVA composite in a film shape.

Example 2: A PVA composite was manufactured in the same manner as in Example 1, except that poly acrylic acid having a Mw of 100,000 was used.

Example 3: A PVA composite was manufactured in the same manner as in Example 1, except that 5 g of polyvinyl alcohol was added to 250 g of deionized water when preparing a polyvinyl alcohol solution, 1.25 g of poly acrylic acid having a Mw of 100,000 was added to 50 g of deionized water when preparing a poly acrylic acid solution, and a Teflon mold had a thickness of 3 mm.

Example 4: A PVA composite was manufactured in the same manner as in Example 3, except that poly acrylic acid having a Mw of 250,000 was used.

Example 5: A PVA composite was manufactured in the same manner as in Example 4, except that 20 g of polyvinyl alcohol was added to 250 g of deionized water when preparing a polyvinyl alcohol solution, and 5 g of poly acrylic acid having a Mw of 250,000 was added to 50 g of deionized water when preparing a poly acrylic acid solution.

Example 6: A PVA composite was manufactured in the same manner as in Example 5, except that 20 g of polyvinyl alcohol was added to 180 g of deionized water when preparing a polyvinyl alcohol solution.

### Experimental Examples: Visual Assessment

Examples 1, 4, 5, and 6 produced yellow films, and Examples 2 and 3 produced red films.

### Experimental Examples: Water Vapor Permeability Measurement

The water vapor permeability analysis was conducted in accordance with the ASTM F1249-20, and measured using PERMATRAN-W 3/33 (manufactured by MOCON Co., USA). The test area was 5 cm² and the measuring range of the equipment is 0.05 g/m²·day to 100 g/m²·day. Water vapor permeability greater than 100 g/m²·day is not measured. Examples 1 to 4 were measured under the condition of relative humidity of 40%, R.H., Example 5 was measured under the conditions of relative humidity of 50%, 70%, and 80%, R.H., respectively, and Example 6 was measured under the condition of relative humidity of 80%, R.H.

### Experimental Examples: Oxygen Permeability Measurement

The oxygen permeability analysis was conducted in accordance with the ASTM D3985-17, and measured using OX-TRAN 2/21 (manufactured by MOCON Co., USA). The test area was 5 cm² and the measuring range of the equipment is 0.05 g/m²·day to 2,000 g/m²·day. Oxygen permeability greater than 2,000 g/m²· day is not measured.

The measurement results of water vapor permeability and oxygen permeability are shown in Table 1 below. The water vapor permeability and the oxygen permeability were each measured twice and the average value thereof are shown.

TABLE 1

| | | | Relative | | |
|---|---|---|---|---|---|
| | | | humidity | | Water |
| | PVA in PVA | Molecular | when | Oxygen | vapor |
| | solution:Solvent | weight of | measured | permeability | permeability |
| Classification | weight ratio | PAA (Mw) | (%, R.H.) | (cc/(m² · day)) | (g/(m² · day)) |
| Example 1 | 1:12.5 | 25000 | 40 | 10.11 | 0.24 |
| Example 2 | 1:12.5 | 100000 | 40 | 9.85 | 0.775 |
| Example 3 | 1:50 | 100000 | 40 | 15.89 | 0.745 |
| Example 4 | 1:50 | 250000 | 40 | 0.59 | 0.515 |
| Example 5 | 1:12.5 | 250000 | 50 | 0.018 | 0.1375 |
| Example 5 | 1:12.5 | 250000 | 70 | 0.018 | 0.117 |
| Example 5 | 1:12.5 | 250000 | 80 | 0.018 | 4.8755 |
| Example 6 | 1:9 | 250000 | 80 | 0.010 | 4.2165 |

When comparing Example 3 and Example 4, it can be seen that Example 4 using PAA having a molecular weight 250,000 had significantly improved both oxygen permeability and water vapor permeability compared to Example 3 using PAA having a molecular weight of 100,000.

When comparing Example 4 and Example 5, it can be seen that Example 5 in which the weight ratio of PVA:solvent was 1:12.5 when preparing a PVA solution improved both oxygen permeability and water vapor permeability compared to Example 4 in which the weight ratio thereof was 1:50. In addition, when comparing Example 5 and Example 6, it can be seen that Example 6 in which the weight ratio of PVA:solvent was 1:9 when preparing a PVA solution improved both oxygen permeability and water vapor permeability compared to Example 5 in which the weight ratio thereof was 1:12.5.

A PVA composite and a manufacturing method thereof according to an embodiment of the present disclosure provide a PVA composite with excellent hydrophobicity.

In addition, the PVA composite manufactured by the present disclosure has excellent biodegradability.

In addition, the PVA composite manufactured by the present disclosure has excellent oxygen barrier properties.

The disclosure is not limited by the above-described embodiments and the accompanying drawings but is intended to be limited by the appended claims. Accordingly, various types of substitutions, modifications, and changes may be made by those skilled in the art within the scope not departing from the technical spirit of the present disclosure described in the claims, and these substitutions, modifications, and changes may also belong to the scope of the present disclosure.

What is claimed is:

1. A PVA composite comprising:
polyvinyl alcohol (PVA); and
poly acrylic acid (PAA),
wherein the content of the poly acrylic acid is approximately 20 parts by weight to approximately 30 parts by weight with respect to 100 parts by weight of the polyvinyl alcohol.

2. The PVA composite of claim 1, wherein the poly acrylic acid has a molecular weight of approximately 100,000 to approximately 500,000.

3. A method for manufacturing a PVA composite, the method comprising:
mixing polyvinyl alcohol (PVA) and poly acrylic acid (PAA) to prepare a mixture; and
heating the mixture,
wherein the content of the poly acrylic acid is approximately 20 parts by weight to approximately 30 parts by weight with respect to 100 parts by weight of the polyvinyl alcohol.

4. The method of claim 3, wherein the preparing of the mixture comprises preparing a polyvinyl alcohol solution, preparing a poly acrylic acid solution, and mixing the polyvinyl alcohol solution and the poly acrylic acid solution.

5. The method of claim 3, wherein the heating of the mixture is heating the mixture to approximately 160° C. to approximately 180° C.
